(19) United States
(12) Patent Application Publication
(10) Pub. No.: US 2010/0182999 A1
(43) Pub. Date: Jul. 22, 2010

(54) SYSTEM AND METHOD FOR PROVIDING A LOCAL NUMBER FOR AN OVERSEAS CALLER TO CALL OR SEND A MESSAGE TO A CALLEE

(76) Inventor: Eng Loo Lee, Singapore (SG)

Correspondence Address: CHRISTIE, PARKER & HALE, LLP, PO BOX 7068, PASADENA, CA, 91109-7068, US

(21) Appl. No.: 12/676,325

(22) PCT Filed: Sep. 4, 2008
(86) PCT No.: PCT/SG08/00325

§ 371 Date: Mar. 3, 2010

(30) Foreign Application Priority Data
Sep. 4, 2007 (SG) 200706297-9

(51) Int. Cl. H04L 12/66; H04M 7/00

(52) U.S. Cl. 370/352; 379/233

(57) ABSTRACT

A system and method for providing a local number for an overseas caller. The system comprises a service provider unit; an interface unit for communication between a callee and the service provider unit, wherein the service provider unit receives a communication from the callee via the interface unit instructing to allocate a DDI number to a caller and creates an association between the DDI number and both the caller and the callee; and a communication device for communication between the service provider unit and the caller for providing the DDI number to the caller.

### FIELD OF INVENTION

The present invention relates broadly to a system and method for providing a local number for an overseas caller to call or send a message to callee.

### BACKGROUND

Most mobile phone or fixed line subscribers use international calling services such as IDD (International Direct Dial) to reach someone overseas. This is regardless of whether the subscriber is using a public phone, fixed line phone, mobile phone, internet phone or instant messaging service. When the subscriber calls the overseas contact the latter may or may not see a caller line identifier (caller ID), depending on the configuration of the telecommunications operators. For cases when caller ID is presented, the overseas contact may call the subscriber back at the same number. The subscriber may also provide his number to the overseas contact directly. However this will be an IDD call when the overseas contact calls the subscriber on this number. IDD charges are known to be cost prohibitive.

A need therefore exists to provide a system and method for providing a local number for an overseas caller to call or send a message to callee that seek to address the above problem.

### SUMMARY

In accordance with a first aspect of the present invention, there is provided a system for providing a local number for an overseas caller, the system comprising a service provider unit; an interface unit for communication between a callee and the service provider unit, wherein the service provider unit receives a communication from the callee via the interface unit instructing to allocate a DDI number to a caller and creates an association between the DDI number and both the caller and the callee; and a communication device for communication between the service provider unit and the caller for providing the DDI number to the caller.

The communication device may comprise a phone device, and the service provider unit provides the IDD number to the caller using via an SMS message or an automated voice call.

The interface unit may comprise a Web portal associated with the service provider unit.

The interface unit may be incorporated in a global communication platform.

The communication device may comprise a device enabled for the global communication platform, and the service provider unit provides the DDI number to the caller using the global communication platform.

The service provider unit may create a look-up table associating the DDI number with both the caller and the callee.

The look-up table may create an exclusive mapping between each caller and callee pair.

In accordance with a second aspect of the present invention, there is provided a method for providing a local number for an overseas caller, the method comprising the steps of providing an interface unit for communication between a callee and a service provider unit; receiving, at the service provider unit, a communication from the callee via the interface unit instructing to allocate a DDI number to a caller; creating an association between the DDI number and both the caller and the callee; and performing a communication between the service provider unit and the caller using a communication device for providing the DDI number to the caller.

The communication device may comprise a phone device, and the service provider unit provides the IDD number to the caller using via an SMS message or an automated voice call.

The interface unit may comprise a Web portal associated with the service provider unit.

The interface unit may be incorporated in a global communication platform.

The communication device may comprise a device enabled for the global communication platform, and the service provider unit provides the DDI number to the caller using the global communication platform.

The method may further comprise, at the service provider unit, creating a look-up table associating the DDI number with both the caller and the callee.

The look-up table may create an exclusive mapping between each caller and callee pair.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic drawing illustrating a system providing a local number for an overseas caller according to an example embodiment.

FIG. 2 shows a flow chart illustrating a method for providing a local number for an overseas caller according to an example embodiment.

FIG. 3 shows a schematic drawings illustrating a computer system for implementing components of a system and method for providing a local number for an overseas caller according to an example embodiment.

### DETAILED DESCRIPTION

In the example embodiments described, by systematically providing a number by which overseas family, friends or other contacts can contact one at local toll charges, significant cost savings can be realized. The number of users sharing a single Direct Dialing In (DDI) number may be limited only by system hardware and infrastructure capacity.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

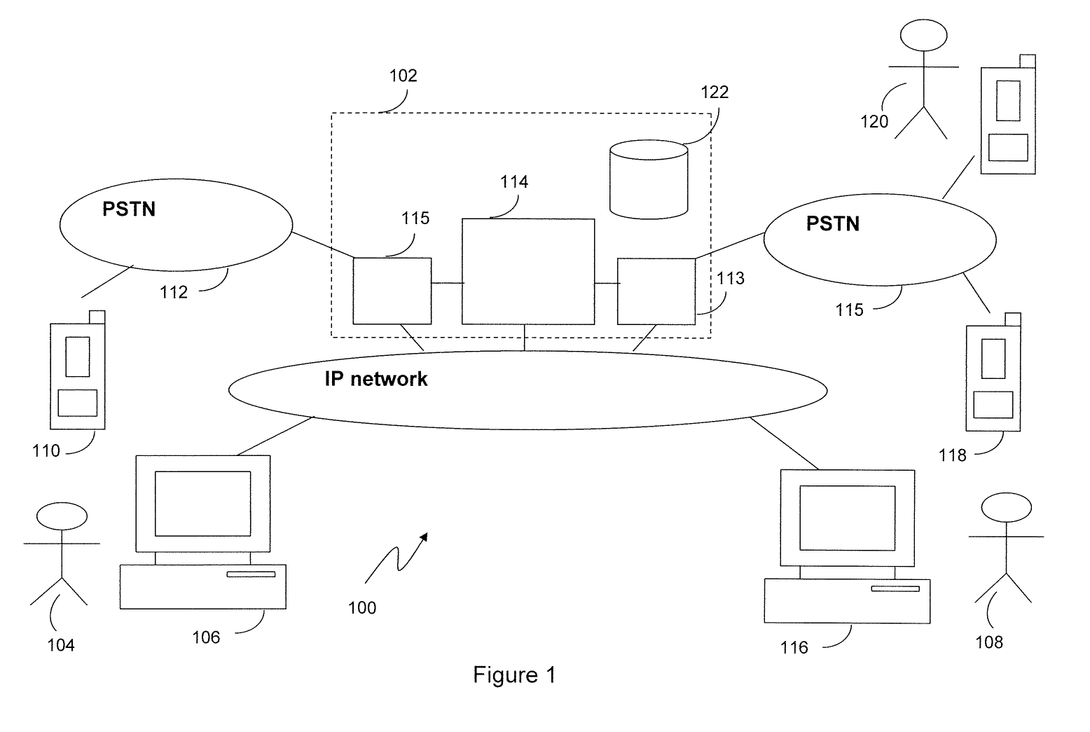

FIG. 1 shows a schematic drawing of a system 100 for providing a local number for overseas callers to call or send a message to a callee. The system comprises a service provider server 102. In this embodiment, subscriber or callee 104 visits a website of the administrator of the service provider server 102 using his or her personal computer (PC) 106. It will be appreciated that the PC 106 is an example device for accessing the website, and the present invention is not limited to access by PC. Instead, it will be appreciated that various other devices may be used to access the website of the administrator of the service provider server 102, including but not limited to laptop computers, personal digital assistant (PDA) devices, mobile phones with internet capabilities, etc.

The callee 104 performs a registration or initiation process on the website of the administrator of the service provider server 102, including registration of a caller identification (ID) of a family member, friend, or other contact 108 for which the callee 104 wishes to provide a local number. For example, the callee 104 may be located in Singapore, whereas the contact 108 may be located in the United Kingdom (UK). In addition to providing the contact's caller ID (e.g. mobile phone or fixed-line phone number), the callee 104 also provides an electronic address, which will be utilized by the service provider server 102 in establishing a contact between the caller 108 and the callee 104, as will be described in more detail below.

The term “electronic address” used throughout the specification is intended to refer to an address that is assigned to electronic devices in context of a telecommunication infra-structure. The term is intended to include, but is not limited to, a phone number (mobile or fixed-line including pagers etc.), email address, instant messaging (IM) address, voice over IP (VoIP) number, or web-address for a web-site on the internet. Electronic addresses are assigned to the devices in order to facilitate communication.

In the example embodiment, the callee 104 provides a caller ID, i.e. phone number, of his or her mobile phone 110. In this example embodiment, the callee's 104 mobile phone 110 is subscribed to a mobile phone network provider 112 operating in Singapore. It will be appreciated that the administrator of the service provider server 102 may be the same or different from the mobile phone network provider 112.

As mentioned above, the callee 104 can provide any other type of electronic address, for example the callee may provide a VoIP number associated with his or her PC 106 or other VoIP enabled device.

Upon entering the information as described above by the callee, the service provider server 102 creates an association between the callee's 104 caller ID, the caller's 108 caller ID, and a DDI number local to the location of the caller 108, i.e. in the UK in this example scenario.

The DDI number is a number associated with a local public switched telephone network (PSTN) local to the caller 108. It will be appreciated that the administrator of the service provider server 102 can enter into an arrangement with the operator of the local PSTN for purchase or renting a range of DDI numbers from the operator of the PSTN. The range of numbers are assigned by the administrator of the service provider server 102 to a gateway 113 of the service provider server 102. Different gateways may be provided for different countries in which the service is provided.

The service provider server 102 also includes one or more DDI exchange server module 114 coupled to the gateway 113 for forwarding an inward communication received via the DDI number over the PSTN 115, onward to a designated destination. As described above, this destination may be a system, service provider unit or communication device associated with an electronic address, depending on the set up and configuration initiated by the callee 104. The forwarding is done through the DDI exchange server module 114 over internet protocol (IP) networks as session initiated protocol (SIP) calls in the example embodiment, such that the DDI numbers are essentially VoIP numbers. If the destination communication device is associated with a VoIP number itself, the SIP call can terminate directly at the destination communication device, for example at the PC 106. Alternatively, if the destination communication device is a phone, for example the mobile phone 110 subscribed to the mobile phone network provider 112, the call can proceed via another gateway 115 utilizing another DDI number obtained by the administrators of the service provider server 102 from the local PSTN mobile phone network provider 112 local to the callee 104. It will be appreciated that the callee 104 may separately set up different service definitions on how a call or message from the caller 108 may be processed at the destination.

While it will be appreciated that after the set up by the callee 104, the callee 104 may independently provide the DDI number allocated by the service provider server 102 to the caller 108, in the example embodiment the service provider server 102 provides an automated functionality for notifying the caller 108 of the allocated DDI number.

For example, the service provider server 102 may initiate sending of a short messaging service (SMS) message or a automated voice message to the caller's 108 phone number (i.e. caller ID). Alternatively, the callee 104 may have additionally provided one or more specific electronic addresses for notifying the caller 108 of the DDI number, such as an IM address, email address, VoIP number or a web-address or other specific phone numbers. Furthermore, if the caller 108 is also a user or a subscriber of the service provider server 102, the service provider server 102 may initiate a look-up of electronic addresses associate with the caller 108, for notification of the allocated DDI number using one or more of the stored electronic addresses. Any one or more Of these options of providing the DDI to the caller 108 may be implemented in example embodiments.

In one preferred embodiment, the administrator of the service provider server 102 has entered into an agreement with one or more administrators of global communication platforms such as MSN IM, Skype, or Google. In such an embodiment, the value-added services provided by the service provider server 102 in allocating local DDI numbers to the caller 108 can be integrated in the communication interface of the global communication platform, for example the MSN IM platform. The callee 104 wishing to have a local DDI number provided to the caller 108 in such an embodiment may simply select the caller 108 from his IM contact list on the global communication platform interface, and initiate provision of a local DDI number to the caller 108, for example by pushing a dedicated icon incorporated into the communication platform after selecting the caller 108 from the contact list. Upon initiation of the DDI number allocation request, the service provider server 102, which is coupled to the global communication platform in this example embodiment, automatically initiates the DDI allocation. The caller 104 may be prompted to additionally provide the caller ID of the caller 108, or alternatively the caller ID may be available to the service provider server 102 through an interrogation of a contact profile of the caller 108 on the global communication platform.

Thereafter, the service provider server 102, which is coupled to the global communication platform in this example embodiment as mentioned above, initiates notification of the allocated DDI number to the caller 108 through an IM message on the global communication platform, which the caller 108 can access via a suitable device such as a PC 116, or any other enabled device for the global communication platform.

The caller 108, after having been notified of the local DDI number in one of the various ways described above with reference to FIG. 1, is now in a position to contact the callee 104 using the local DDI number. The caller 108 makes a local call from a device associated with the caller ID for which the association with the DDI number has been set up. The device may e.g. be a fixed-line phone or a mobile phone. Upon the caller 108 dialing the allocated DDI number from the device, for example from mobile phone 118 associated with the relevant caller ID for which the association has been set up, the DDI exchange server module 114 forwards the inward communication onward to the designated destination, for example to the caller ID associated with the mobile phone 110 of the callee 104. As described above, different destination devices may be associated with the caller ID. The DDI exchange server module 114 can identify the relevant caller ID for the callee 104 through the exclusive mapping that exists between the callee 104 and caller 108 pair by way of the allocated DDI number.

In the described embodiments, each DDI may be shared by multiple callers in the same country, as illustrated in FIG. 1 in the case of UK, where device users 108 and 120 both use the same UK DDI number to reach the callee 104 in SG (Singapore). A DDI may also be shared by multiple callees for different callers. An exclusive mapping exists between each caller and callee pair by way of the DDI allocated.

The service provider server 102 may comprise a database 122, and the service provider server 102 identifies the callee based on interrogating a lookup table based on the caller ID and the DDI called by the caller.

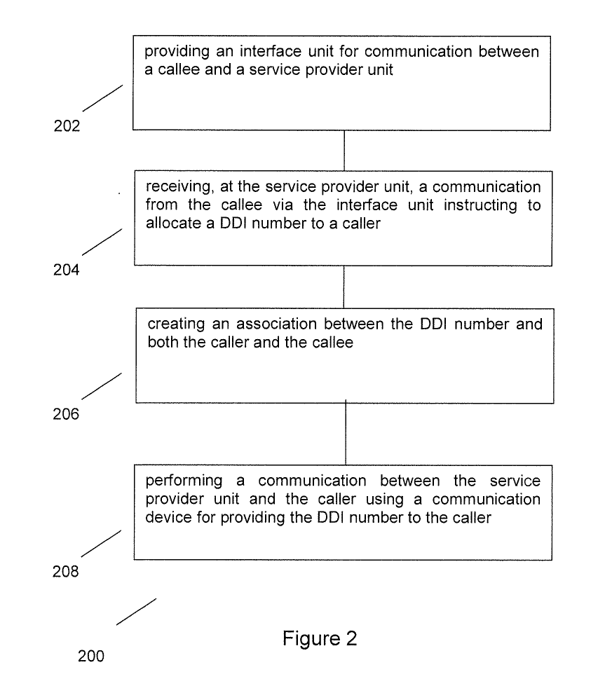

FIG. 2 shows a flow chart 200 illustrating a method for providing a local number for an overseas caller according to an example embodiment. At step 202, an interface unit for communication between a callee and a service provider unit is provided. At step 204, at the service provider unit, a communication is received from the callee via the interface unit instructing to allocate a DDI number to a caller. At step 206, an association is created between the DDI number and both the caller and the callee. At step 208, a communication is performed between the service provider unit and the caller using a communication device for providing the DDI number to the caller.

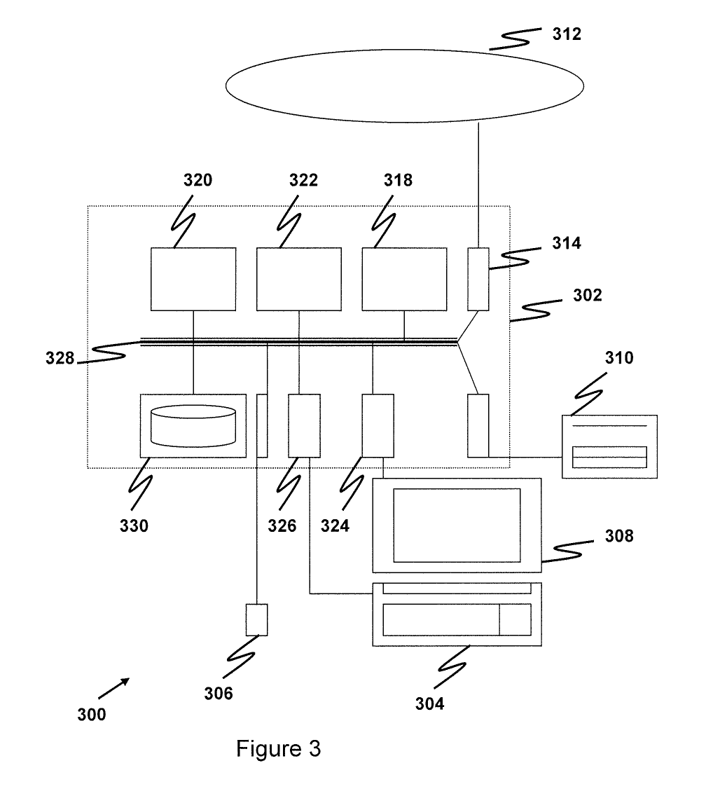

Components of method and system of the example embodiment can be implemented on respective computer systems 300, schematically shown in FIG. 3. They may be implemented as software, such as a computer program being executed within the computer system 300, and instructing the computer system 300 to conduct respective component of the method of the example embodiment.

The computer system 300 comprises a computer module 302, input modules such as a keyboard 304 and mouse 306 and a plurality of output devices such as a display 308, and printer 310.

The computer module 302 is connected to a computer network 312 via a suitable transceiver device 314, to enable access to e.g. the Internet or other network systems such as Local Area Network (LAN) or Wide Area Network (WAN).

The computer module 302 in the example includes a processor 318, a Random Access Memory (RAM) 320 and a Read Only Memory (ROM) 322. The computer module 302 also includes a number of Input/Output (I/O) interfaces, for example I/O interface 324 to the display 308, and I/O interface 326 to the keyboard 304.

The components of the computer module 302 typically communicate via an interconnected bus 328 and in a manner known to the person skilled in the relevant art.

The application program is typically supplied to the user of the computer system 300 encoded on a data storage medium such as a CD-ROM or flash memory carrier and read utilizing a corresponding data storage medium drive of a data storage device 330. The application program is read and controlled in its execution by the processor 318. Intermediate storage of program data maybe accomplished using RAM 320.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1-23. (canceled)

24. A system for providing a local number for an overseas caller, the system comprising:
a service provider unit;
an interface unit for communication between a callee and the service provider unit, wherein the service provider unit receives a communication from the callee via the interface unit instructing to allocate a DDI number to a caller, the DDI number being local to the caller, and creates an association between the DDI number and both the caller and the callee; and
a communication device for communication between the service provider unit and the caller for providing the DDI number to the caller.

25. The system as claimed in claim 24, wherein the communication device comprises a phone device, and the service provider unit provides the DDI number to the caller using an SMS message or an automated voice call.

26. The system as claimed in claim 24, wherein the interface unit comprises a Web portal associated with the service provider unit.

27. The system as claimed in claim 24, wherein the interface unit is incorporated in a global communication platform.

28. The system as claimed in claim 24, wherein the communication device comprises a device enabled for a global communication platform including one or more of a group consisting of Instant Messaging, email, Voice over IP, or web, and the service provider unit provides the DDI number to the caller using the global communication platform.

29. The system as claimed in claim 24, wherein the service provider unit creates a look-up table associating the DDI number with both the caller and the callee.

30. The system as claimed in claim 29, wherein the look-up table creates an exclusive mapping between each caller and callee pair.

31. A method for providing a local number for an overseas caller, the method comprising the steps of:
providing an interface unit for communication between a callee and a service provider unit;
receiving, at the service provider unit, a communication from the callee via the interface unit instructing to allocate a DDI number to a caller, the DDI number being local to the caller;
creating an association between the DDI number and both the caller and the callee; and
performing a communication between the service provider unit and the caller using a communication device for providing the DDI number to the caller.

32. The method as claimed in claim 31, wherein the communication device comprises a phone device, and the service provider unit provides the DDI number to the caller using an SMS message or an automated voice call.

33. The method as claimed in claim 31, wherein the interface unit comprises a Web portal associated with the service provider unit.

34. The method as claimed in claim 31, wherein the interface unit is incorporated in a global communication platform.

35. The method as claimed in claim 31, wherein the communication device comprises a device enabled for a global communication platform including one or more of a group consisting of Instant Messaging, email, Voice over IP, or web, and the service provider unit provides the DDI number to the caller using the global communication platform.

36. The method as claimed in claim 31, further comprising, at the service provider unit, creating a look-up table associating the DDI number with both the caller and the callee.

37. The method as claimed in claim 36, wherein the look-up table creates an exclusive mapping between each caller and callee pair.

38. A data storage medium having stored thereon computer code means for instructing a computer to execute a method for providing a local number for an overseas caller, the method comprising the steps of:
providing an interface unit for communication between a callee and a service provider unit;
receiving, at the service provider unit, a communication from the callee via the interface unit instructing to allocate a DDI number to a caller, the DDI number being local to the caller;
creating an association between the DDI number and both the caller and the callee; and
performing a communication between the service provider unit and the caller using a communication device for providing the DDI number to the caller.

39. The system as claimed in claim 24, wherein the interface unit is configured such that the association between the DDI number and both the caller and the callee identifies of a plurality of electronic addresses for the callee.

40. The system as claimed in claim 24, wherein the interface unit is configured such that the association between the DDI number and both the caller and the callee identifies service definitions on how a call or message may be processed.

41. The system as claimed in claim 24, wherein the service definition comprises contacting the callee on a Voice over Internet Protocol number.

42. The system as claimed in claim 24, wherein a call from the caller is forwarded over Internet Protocol networks.

43. The method as claimed in claim 31, wherein creating the association between the DDI number and both the caller and the callee comprises identifying a plurality of electronic addresses for the callee.

44. The method as claimed in claim 31, wherein creating the association between the DDI number and both the caller and the callee comprises identifying service definitions on how a call or message may be processed.

45. The system as claimed in claim 31, wherein the service definition comprises contacting the callee on a Voice over Internet Protocol number.

46. The system as claimed in claim 31, wherein a call from the caller is forwarded over Internet Protocol networks.
